(19) United States
(12) Patent Application Publication
(10) Pub. No.: US 2017/0109771 A1
(43) Pub. Date: Apr. 20, 2017

(54) REORDER TRACKING AND CREDIT ATTRIBUTION

(71) Applicant: Amway Corp., Ada, MI (US)

(72) Inventors: Aaron L. Sundman, Rockford, MI (US); Thomas D. Paasche, Grand Rapids, MI (US)

(73) Assignee: Amway Corp., Ada, MI (US)

(21) Appl. No.: 15/292,763

(22) Filed: Oct. 13, 2016

Related U.S. Application Data
(60) Provisional application No. 62/242,612, filed on Oct. 16, 2015.

(51) Int. Cl. G06Q 30/02; G06K 7/14; G06K 7/10; G06Q 30/06

(52) U.S. Cl. CPC G06Q 30/0214; G06Q 30/0635; G06Q 30/0225; G06K 7/1417; G06K 7/10366

(57) ABSTRACT

A system is disclosed for tracking and assigning credit to a direct seller in a multi-level marketing organization for reorders of a product. Products are tagged/labeled with a unique identifier that is used in the reorder process. A database associates the unique identifier with the seller and based on that association, the seller is credited with the reorder sale. The unique identifier may be part of a QR code, RFID tag, or other mechanism for encapsulating the unique identifier for use during the reorder process. The unique identifier may also be used for additional product tracking/monitoring and for fraud prevention.

### PRIORITY

This application claims priority to U.S. Provisional App. No. 62/242,612, filed on Oct. 16, 2015, entitled “REORDER TRACKING AND CREDIT ATTRIBUTION,” the entire disclosure of which is hereby incorporated by reference. This application is related to U.S. patent application Ser. No. ______, filed on Oct. 13, 2016, entitled “REORDER TRACKING AND CREDIT ATTRIBUTION,” and PCT App. No. ______, filed on Oct. 13, 2016, entitled “REORDER TRACKING AND CREDIT ATTRIBUTION,” the entire disclosures of both are hereby incorporated by reference.

### BACKGROUND

In a multi-level marketing (“MLM”) business, a seller is assigned credit for sales by the seller or by the seller's downline of additional sellers. Direct selling of products may be difficult to track in order for correctly identifying sales credit for particular sales. In particular, re-orders of products may not be easily assigned to an original seller of the product. Improved tracking of products and reordering may be useful in a multilevel marketing organization.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 illustrates a block diagram of an exemplary computing system.

FIG. 2 illustrates a block diagram of an exemplary tracker apparatus.

FIG. 3 illustrates a multilevel marketing selling organization.

FIG. 4 is a flow chart for product tracking and crediting.

FIG. 5 illustrates an exemplary database.

FIG. 6 illustrates an exemplary link encoded in a tag or code.

FIG. 7 illustrates examples for encoding unique identifiers.

FIG. 8 illustrates a redirecting of a link with a unique identifier.

FIG. 9 illustrates exemplary functions provided to a user with the unique identifier.

FIG. 10 illustrates an exemplary seller contact screen.

FIG. 11 illustrates seller order processing screen.

FIG. 12 illustrates the order processing with a receipt.

FIG. 13 illustrates tracking information associated with the unique identifier.

FIG. 14 illustrates the labeling of a group of products.

FIG. 15 illustrates an integration of social media.

### DETAILED DESCRIPTION

By way of introduction, the disclosed embodiments relate to systems and methods for tracking product reorders and providing credit within a MLM organization. The system may assign a unique identifier (i.e. guaranteed unique ID) to each product that can be associated with an order and/or the seller of the product. Reorders of the product can then be attributed to the seller because of the unique identifier. In one embodiment, the unique identifier may be a bar code or optical code (e.g. a two dimensional bar code or a quick response (“QR”) code) that is scanned upon an initial sale for assignment and upon a reorder or a resale, the original seller can be credited within the MLM organization.

In particular, the disclosed systems and methods track and assign credit to a direct seller in a multi-level marketing organization for reorders of a product. Products are tagged/labeled with a unique identifier that is used in the reorder process. A database associates the unique identifier with the seller and based on that association, the seller is credited with the reorder sale. The unique identifier may be part of a QR code, RFID tag, or other mechanism for encapsulating the unique identifier for use during the reorder process. The unique identifier may also be used for additional product tracking/monitoring and for fraud prevention. This fraud detection may be in real-time because a purchase of a product in the wrong country can be instantly identified when the unique identifier includes a country code for each product.

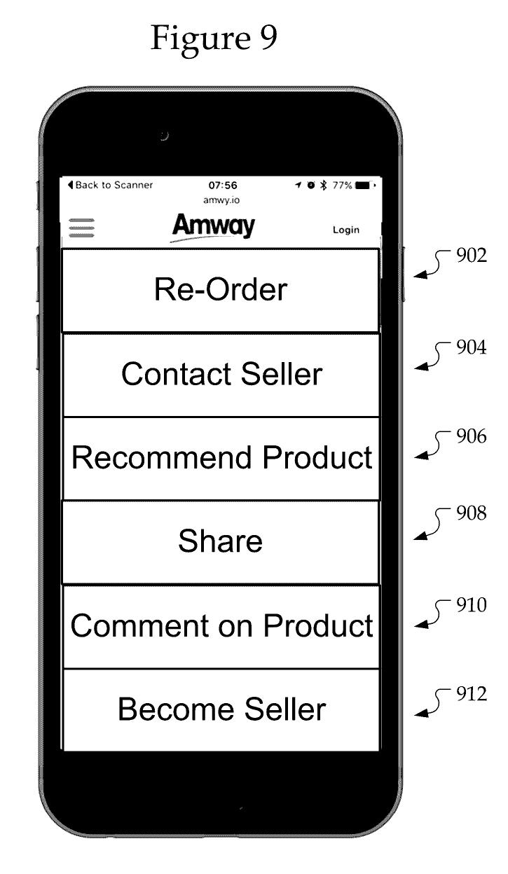

An order (or reorder) process may begin when a user scans a tag/code. In one embodiment, this scanning may be automated such that when a mobile device of the user is within range of the product, information encoded by the tag/code is identified and transmitted as part of the reorder process. This may be through any form of wireless communication including but not limited to NFC or Bluetooth. For example, setting your smartphone (e.g. user device 102) on a package may cause the tag from the package to be read and may immediately allow the unique ID to be identified and the user may be presented options as shown in FIG. 9, as discussed below. The tag/code may be near field coding (NFC) or an optical code (e.g. UPC or QR code).

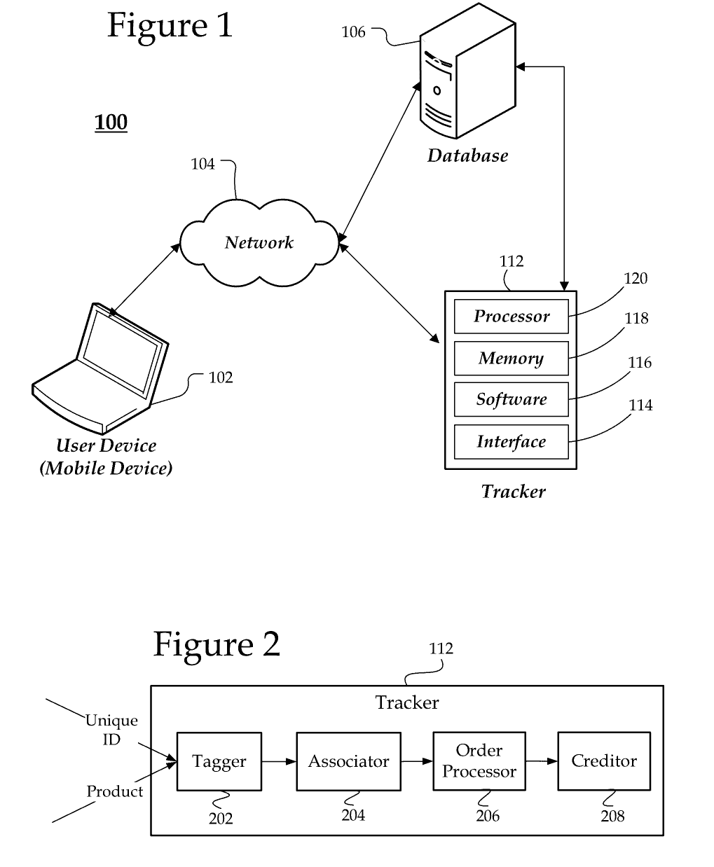

The reordering process and product tracking may be performed by a computer or computing device. The device may be part of a network (i.e. a computer network such as the Internet) for communicating information about the network and/or IDs. FIG. 1 illustrates a block diagram of an exemplary computing system 100. The system 100 may include functionality for unique identifier generation, tagging, associating, tracking, and order processing. In the system 100, a user device 102 is coupled with a database106 through a network 104. The tracker 112 may be or be coupled with a web server that distributes data from the network 104. The tracker 112 may be coupled with the network 104 and/or the database106. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided.

The user device 102 may be a computing device which allows a user to connect to the network 104, such as the Internet. Examples of a user device include, but are not limited to, a mobile device, a personal computer, personal digital assistant (“PDA”), cellular phone, or other electronic device. The user device 102 may be configured to allow a user to interact with the database106, the tracker 112, or other components of the system 100. The user device 102 may include a keyboard, keypad or a cursor control device, such as a mouse, or a joystick, touch screen display, remote control or any other device operative to allow a user to interact with the database106 and/or the via the user device 102. The user device 102 may be configured to access other data/information in addition to web pages over the network 104 using a web browser, such as INTERNET EXPLORER® (sold by Microsoft Corp., Redmond, Wash.) or FIREFOX (provided by Mozilla). The data displayed by the browser may include requests for an ID, ID information, network tracking, and/or tracking data. In an alternative embodiment, software programs other than web browsers may also display the data over the network 104 or from a different source.

The user deice 102 may include a scanner for scanning a tag from a product. The product tag may encode a unique identifier that can be transmitted to the tracker 112 upon scanning of the tag. In one embodiment, the scanner is a QR scanner and the tag is a QR code. Scanning of the QR code can be used to determine the unique identifier for a particular product and provide options for reordering the product while allowing for the original seller to receive credit for the reordering because the unique identifier points to a series of records in the database identifying seller who sold the original product.

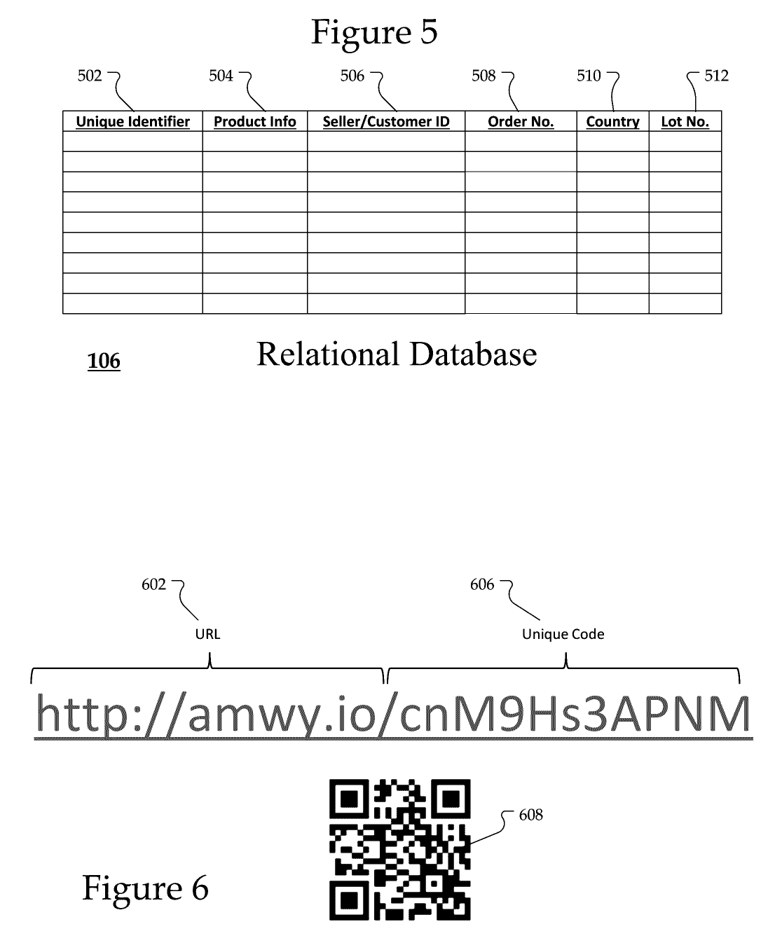

The database106 may be a database that stores unique identifiers and the products/sellers associated with each of the unique identifiers. The association stored in the database 106 may be accessed by the tracker 112. In one embodiment, the database 106 may be combined with or part of the tracker 112, such as the memory 118. An example of the database stored in the database 106 is illustrated in FIG. 5. Although not shown, the database 106 may be replaced with or supplemented by a cloud-based application program interface (API) for storing and/or controlling the data. For simplicity, references to the data stored in the database 106 (e.g. FIG. 5) may be stored in the cloud rather than a physical database or in addition to the database 106.

The tracker 112 may be a computing device for performing ordering and tracking related functions. The tracker 112 is further illustrated in FIG. 2. The tracker 112 may include a processor 120, a memory 118, software 116 and an interface 114. In alternative embodiments, the tracker 112 may be multiple devices to provide different functions and it may or may not include all of the interface 114, the software 116, the memory 118, and/or the processor 120.

The interface 114 may be a user input device or a display. The interface 114 may include a keyboard, keypad or a cursor control device, such as a mouse, or a joystick, touch screen display, remote control or any other device operative to allow a user or administrator to interact with the tracker 112. The interface 114 may communicate with any of the user device 102, the database106, and/or the tracker 112. The interface 114 may include a user interface configured to allow a user and/or an administrator to interact with any of the components of the tracker 112. For example, the administrator and/or user may be able to access the database through the interface 114. The interface 114 may include a display coupled with the processor 120 and configured to display an output from the processor 120. The display (not shown) may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 120, or as an interface with the software 116 for providing data.

The processor 120 in the tracker 112 may include a central processing unit (CPU), a graphics processing unit (GPU), a digital signal processor (DSP) or other type of processing device. The processor 120 may be a component in any one of a variety of systems. For example, the processor 120 may be part of a standard personal computer or a workstation. The processor 120 may be one or more general processors, digital signal processors, application specific integrated circuits, field programmable gate arrays, servers, networks, digital circuits, analog circuits, combinations thereof, or other now known or later developed devices for analyzing and processing data. The processor 120 may operate in conjunction with a software program, such as code generated manually (i.e., programmed).

The processor 120 may be coupled with the memory 118, or the memory 118 may be a separate component. The software 116 may be stored in the memory 118. The memory 118 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 118 may include a random access memory for the processor 120. Alternatively, the memory 118 may be separate from the processor 120, such as a cache memory of a processor, the system memory, or other memory. The memory 118 may be an external storage device or database for storing recorded tracking data, or an analysis of the data. Examples include a hard drive, compact disc (“CD”), digital video disc (“DVD”), memory card, memory stick, floppy disc, universal serial bus (“USB”) memory device, or any other device operative to store data. The memory 118 is operable to store instructions executable by the processor 120.

The functions, acts or tasks illustrated in the figures or described herein may be performed by the programmed processor executing the instructions stored in the memory 118. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 120 is configured to execute the software 116.

The present disclosure contemplates a computer-readable medium that includes instructions or receives and executes instructions responsive to a propagated signal, so that a device connected to a network can communicate voice, video, audio, images or any other data over a network. The interface 114 may be used to provide the instructions over the network via a communication port. The communication port may be created in software or may be a physical connection in hardware. The communication port may be configured to connect with a network, external media, display, or any other components in system 100, or combinations thereof. The connection with the network may be a physical connection, such as a wired Ethernet connection or may be established wirelessly as discussed below. Likewise, the connections with other components of the system 100 may be physical connections or may be established wirelessly.

Any of the components in the system 100 may be coupled with one another through a (computer) network, including but not limited to the network 104. For example, the tracker 112 may be coupled with the database 106 and/or the user device 102 through a network. Accordingly, any of the components in the system 100 may include communication ports configured to connect with a network. The network or networks that may connect any of the components in the system 100 to enable communication of data between the devices may include wired networks, wireless networks, or combinations thereof. The wireless network may be a cellular telephone network, a network operating according to a standardized protocol such as IEEE 802.11, 802.16, 802.20, published by the Institute of Electrical and Electronics Engineers, Inc., or WiMax network. Further, the network(s) may be a public network, such as the Internet, a private network, such as an intranet, or combinations thereof, and may utilize a variety of networking protocols now available or later developed including, but not limited to TCP/IP based networking protocols. The network(s) may include one or more of a local area network (LAN), a wide area network (WAN), a direct connection such as through a Universal Serial Bus (USB) port, and the like, and may include the set of interconnected networks that make up the Internet. The network(s) may include any communication method or employ any form of machine-readable media for communicating information from one device to another.

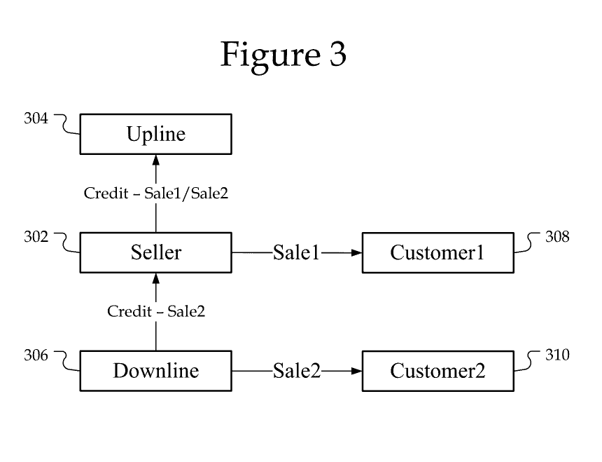

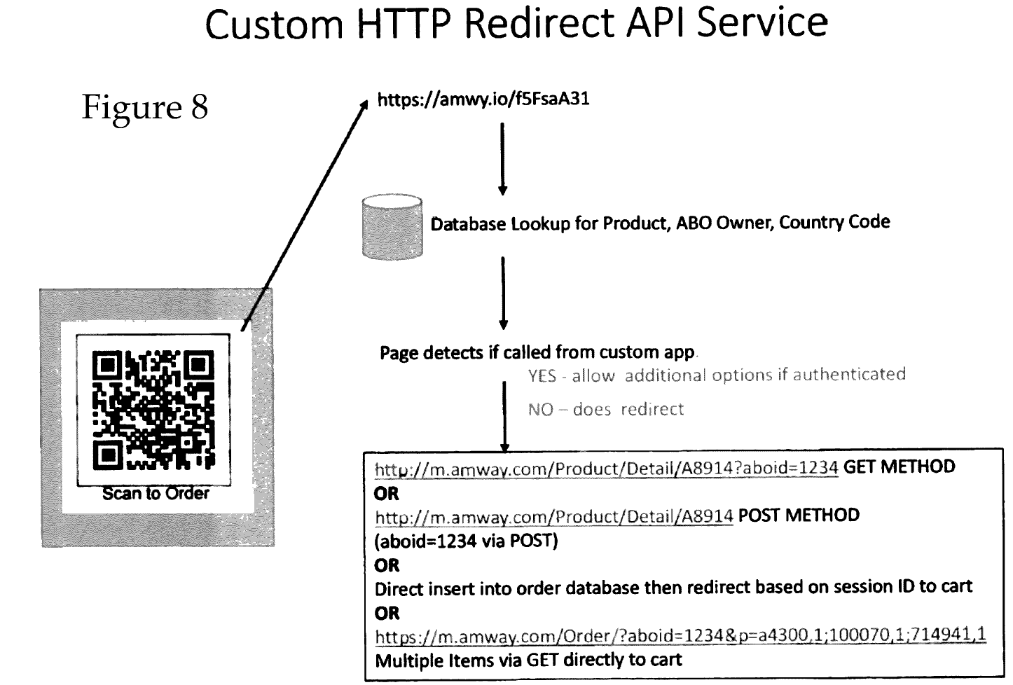

FIG. 2 illustrates a block diagram of an exemplary tracker 112. The tracker may receive a unique identifier (ID) which is then associated with a product. In one embodiment, every product can be tagged or coded with a different unique identifier by a tagger 202. The unique identifier can then be associated with different information by the associator 204. The information associated with the unique identifier is further described below with respect to FIG. 8 but may include a seller of the product. In a multilevel marketing organization, direct selling of a product may result in credit for each sale, which must be tracked. The use of the unique identifier for every product that is different allows for every sale or re-sale of product to be associated with the original seller. FIG. 9 illustrates exemplary forms the unique identifier can be encoded with. The tracker 112 can receive an order request with the order processor 206 that utilizes the unique identifier to identify a seller for each product in the order request. The order request may be for re-sale of the original product. The re-sale may be accomplished using the tag or code to initiate the re-order process. Because the unique identifier is encoded in the tag or code, the reordering can be associated with the original seller. The creditor 208 can then provide the seller with credit for the order/reorder. The credit may be from a direct selling network or multilevel marketing organization as further described with respect to FIG. 3.

FIG. 3 illustrates a multilevel marketing selling organization. FIG. 3 illustrates a seller 302. The multilevel marketing organization for the seller 302 includes an upline 304 for the seller 302 and a downline 306 for the seller 302. The upline 304 may receive credit the sale of all of their downline (including seller 302 and the downline 306). Likewise, the seller 302 receives credit for any sales by the downline 306. The downline 306 may be other sellers that were recruited by the seller 302 to join the multilevel marketing organization. The seller 302 completes a sale1 to a customer1 308. Credit for sale1 goes to the seller 302 and the upline 304. Likewise, if the down line 306 completes a sale2 with a customer2 310, credit for sale2 goes to the seller 302 and the upline 304. Accordingly, customer purchases of products from the multilevel marketing organization should be credited to the proper seller. The credit may include point value PV and business volume BV (PV/BV) in the example of AMWAY.

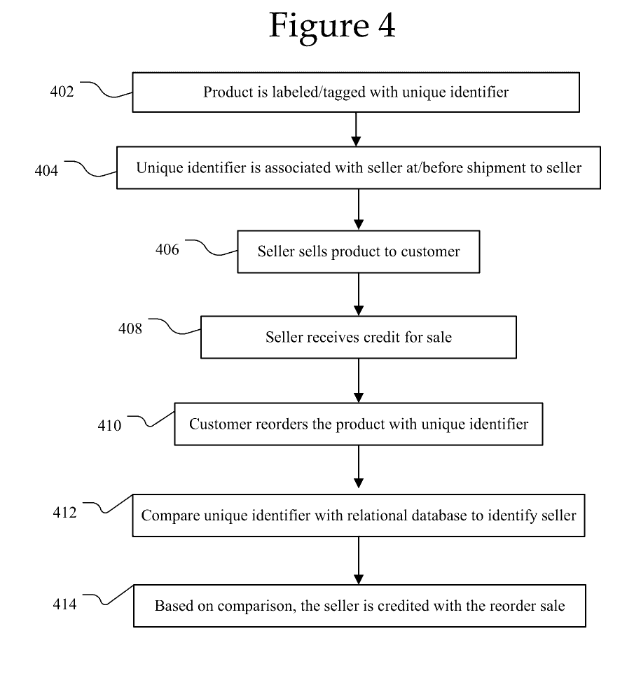

FIG. 4 is a flow chart for product tracking and crediting. In block 402, a product is labeled or tagged with a unique identifier. The unique identifier is further described below with respect to FIGS. 5-7. Every product may be assigned a different unique identifier. In block 404, the unique identifier is associated with the seller that receives the product. The association may be made in a database (e.g. database 106) as further described below with respect to FIG. 5. In one embodiment, the database may include a relational database and may be referred to as such for simplicity. The seller receives the product and the database 106 includes an association of the seller with the unique identifier for the product that the seller received. In block 406, the seller may sell the product to a customer and receive credit for the sale in block 408. However, when the customer desires to reorder the product in block 410, the customer may or may not remember the original seller of the product. The label/tag can be used to expedite the reorder process (e.g. scanning the QR code takes the user to a page as shown in FIG. 9 or to a reorder page for the submission of an order request through reorder button 902). The unique identifier encoded in the label/tag ensures that the original seller receives credit for subsequent reorders. The credit may require a reference to a database 106 to identify a seller based on the unique identifier in block 412. The database 106 can identify the original seller who receives credit for subsequent reorders.

FIG. 5 illustrates an exemplary database 106. The database 106 may be a relational database 106 in one embodiment or may be a non relational or non SQL (NoSQL) graph database. The database 106 may associate unique identifiers 502 with other information. The unique identifier 502 may be a text string that is long enough to include enough permutations to cover all products sold by a retailer, but not so long that it cannot be accurately encoded in a tag or label (e.g. QR code).

FIG. 5 illustrates the data stored (column headings), but does not show the actual values for each of the columns. That information may include product information 504, such as a SKU number, serial number, model number, or other identification information for the product. The seller 506 can be identified in the database through a seller number. For example, a seller at AMWAY may be referred to as an Amway Business Owner (ABO) or an Independent Business Owner (IBO). Every product that a seller or ABO orders may each have a different unique identifier, however, all of them may be associated with the seller 506. An order number 508 also be recorded. In one embodiment, the product information 504 and the order number 508 may be stored in a separate database to reduce the size of the database 106. A country code 510 may be utilized to ensure that products (to be sold in a particular country) are in fact sold only in that country. The country code 510 can be used to reduce gray market goods. A lot number 512 may be used for quality assurance purposes. For example, identifying a problem with a particular batch or product may be simplified by identifying a lot for each product. FIG. 16 illustrates a package (i.e. lot 512) that includes a plurality of products. The products would all have different unique identifiers, but would have the same lot number 512.

FIG. 6 illustrates an exemplary link encoded in a tag or code. In one embodiment, the tag or code is a QR code 608. The QR code 608 encodes a link that has a universal resource locator (URL) 602 with a unique identifier 606. The URL 602 may be a shortened URL as shown or may be a complete web address. Clicking of the link shown in FIG. 6 may provide a user with several options (e.g. FIG. 9) including the opportunity to place an order. The link may include the exemplary unique identifier 606. The unique code 606 illustrated in FIG. 6 is merely exemplary and may have more or fewer characters. The unique identifier 606 is encoded in a QR code 608. The URL 602 and may be combined with the unique identifier 606 to form the link shown in FIG. 6. In one embodiment, there may be an artwork code (not shown) that is used to comply with drug manufacturing regulations. In one embodiment, the artwork code may not be part of the URL and may instead be included in the database (not shown in FIG. 5).

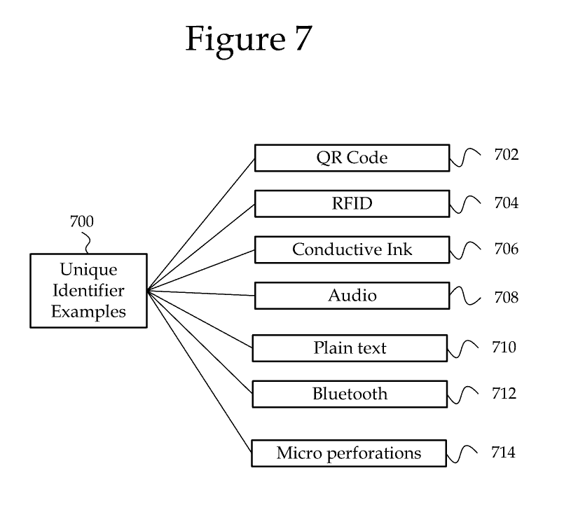

FIG. 7 illustrates examples for encoding unique identifiers. Although the unique identifier 700 is commonly described as being encoded in a QR code 702 that is merely one example. FIG. 7 illustrates other examples of tags/labels that can encode the unique identifier 700. Radio-frequency identification (RFID) 704 may be used to tag each product. A device (e.g. smartphone) that can read RFID can receive the unique identifier and use that for reordering. Conductive ink 706 may be added to product packaging and can be read by a consumer. An audio signal (e.g. CHIRP) 708 may be used to encode the unique identifier. The audio signal may include a spoken code that a user reads from a package. The unique identifier may be shown in plain text 710. Bluetooth 712 is an exemplary wireless technology that may be used for communicating the unique identifier. Micro perforations 714 may be added to the package. Accordingly, the tagging of every product with a different unique identifier may be accomplished various ways. For simplicity, the QR code embodiment is further described below, but it is merely exemplary. The unique identifier 700 can include any other examples of optical codes that can be read by a computing device, mobile phone, or a person. In other examples, the unique identifier provides an identification of a product. This may include any other optical or machine readable code for including the unique IDs.

The unique ID may be created and/or registered using a cloud based application program interface (API). The interface may issue random unique IDs that are then tagged to products. Using a long enough unique ID (e.g. 12 characters) may provide enough random numbers to prevent fraud and allow enough numbers to cover all products. In addition to providing/producing the unique IDs, the cloud-based API may also be used to associate the unique ID with a product and seller (e.g. the association shown in FIG. 5).

FIG. 8 illustrates a redirecting of a link with a unique identifier. The link is activated by a user/consumer that scans a QR code. Activation of the link checks a database for looking up the product, seller (Amway Business Owner (“ABO”) or Independent Business Owner (“IBO”)), and country code, each of which can be found based on the associate with the unique identifier shown in the original link. Accessing the link may be from a custom application or app, such as the AMWAY app. The app determines if the user is authenticated. There may be additional options available for a user that is authenticated as compared with a guest user. The potential GET and POST commands are illustrated in FIG. 8. Alternatively, the link may activate a mobile browser for accessing the product.

FIG. 9 illustrates exemplary functions provided to a user with the unique identifier. In particular, FIG. 9 is a screenshot of exemplary buttons that may be utilized by a user that scans a QR code. In one example, a seller may give a potential consumer a product to try. If the consumer likes the product, they can scan the QR code for the list of options shown in FIG. 9. A user that scans the QR code of a product may be given the option to reorder 902 that product. Because the unique identifier is associated with the seller in the database, any reordering by the user will be credited to the seller who sold the original product. The consumer may also be provide with the opportunity to contact the seller 904.

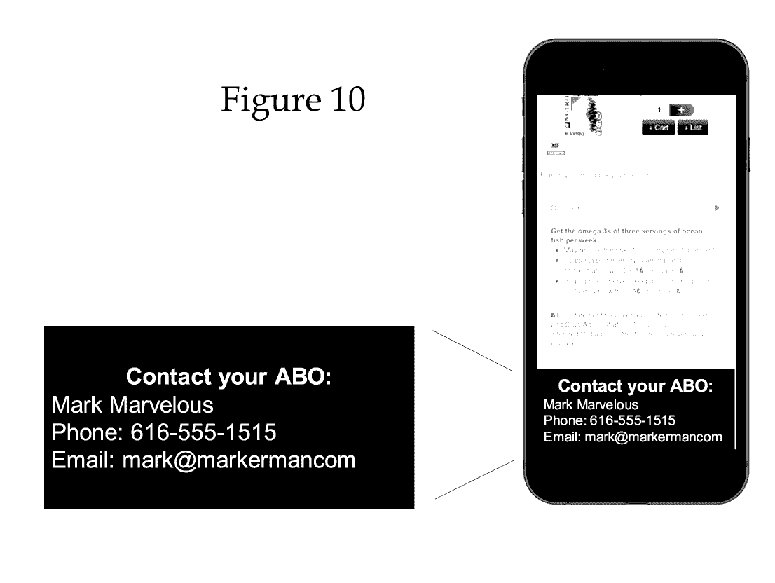

FIG. 10 illustrates an exemplary seller contact screen. When the consumer selects to click the contact the seller button 904, the contact information may be shown on the device as in FIG. 10. Any of the contact may be activated by the phone (e.g. click on the phone number to send a text message or initiate a phone call) including clicking on the email address to send the seller an email.

Referring back to FIG. 9, the consumer may have the option of recommending the product 906 or sharing 908 the product through social media or other forms of communication. The user can also provide feedback on the product 910. Finally, the consumer may wish to join the multilevel marketing organization as shown by the seller button 912 allowing the user to pursue the business opportunity of being a direct seller.

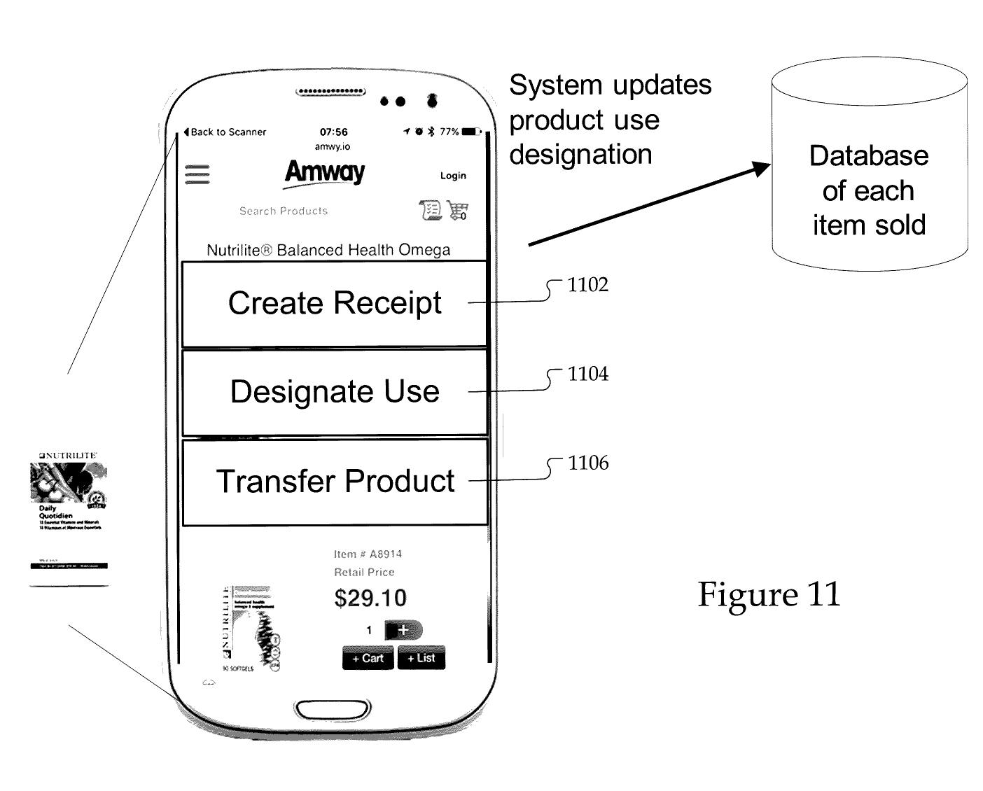

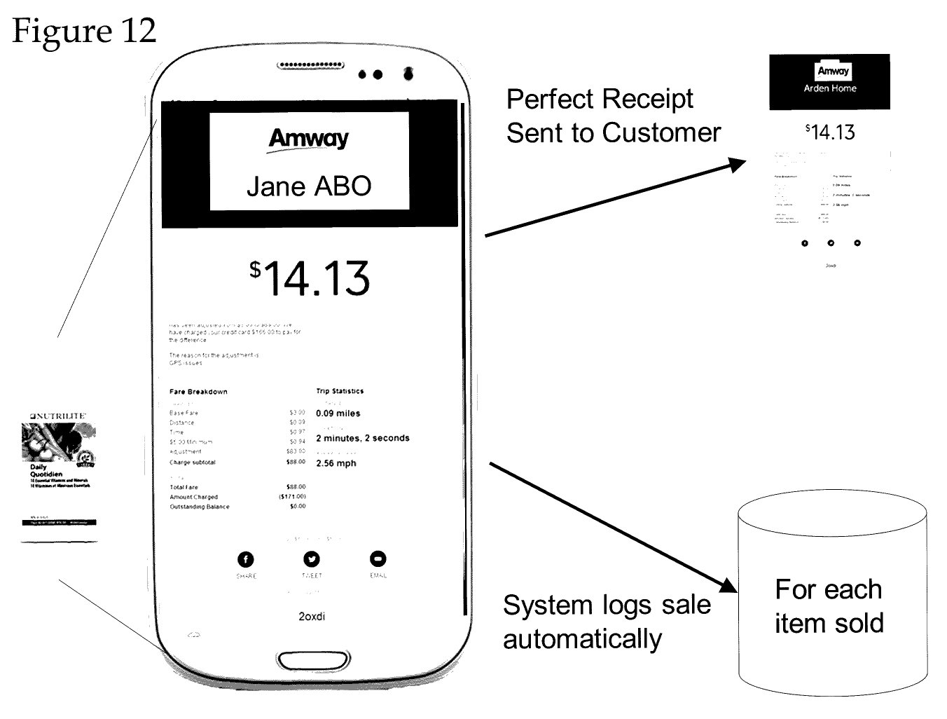

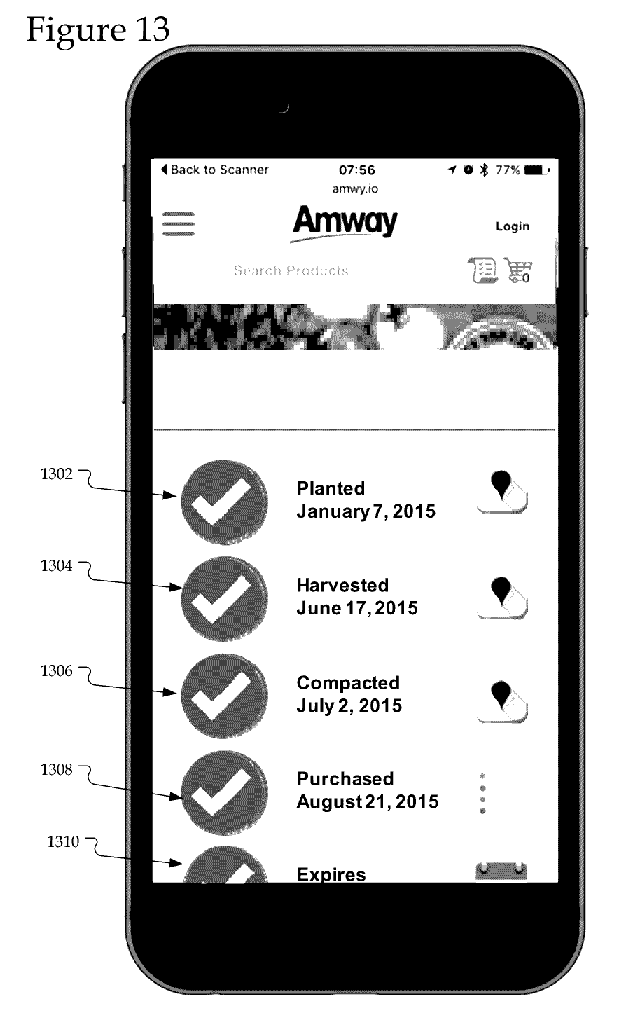

FIG. 11 illustrates seller order processing screen. When a potential customer of seller wishes to place an order for a product, the seller can process the sale and create a receipt 1102. The sale and receipt are recorded in a database of each item sold. FIG. 12 illustrates the order processing with a receipt. In particular the seller can submit the order through a mobile device (e.g. on the AMWAY app) and select to have the receipt sent directly to the consumer. Each sale may be logged automatically. The receipt or invoice for a prospective client may be through email or another messaging service when a printer is unavailable. When the seller is logged in to the device (or logged into the app), this pre-authentication may allow for access to all features. Referring back to FIG. 11, the seller can designate use 1104 in which the product may be for the personal use of the seller. Finally, the seller may transfer product 1106 in which the seller provides the product to his/her downline for trial or resale. Any subsequent sales by the downline after this transfer may result in a credit that goes to the seller who transferred the product. However, for the transfer, the unique ID is changed from being associated with the seller to the seller's downline (who received the transfer/sale). In other words, the transfer product 1106 includes a transfer of the unique ID, which is updated to reflect the transferee.

FIG. 13 illustrates tracking information associated with the unique identifier. FIG. 13 illustrates how a product or lot number may be tracked by using the unique identifier. For example, the planting time 1302, harvesting time 1304, compaction time 1306, purchase time 1308, and expiration time 1310 may be accessible. This information may be very accurate because the unique identifier can be used to track every product. The use of the lot number field may provide this information for a plurality of products. Other examples of data that can be tracked using unique identifiers include supply chain, recalls, manufacture date, manufacture location, and/or quality checks.

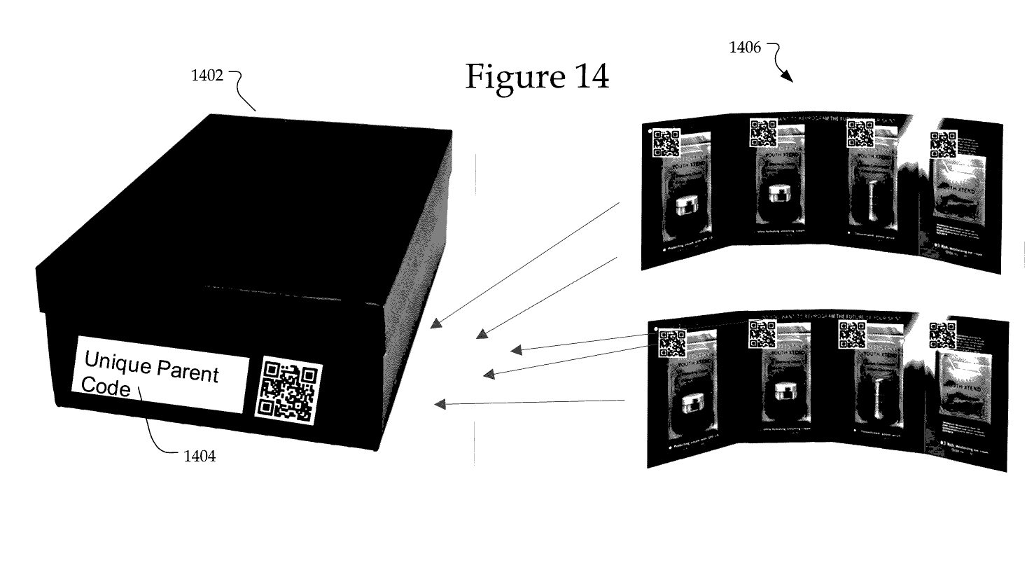

FIG. 14 illustrates the labeling of a group of products. As shown in FIG. 14, a group of products 1406 may be packaged together. For simplicity, the package 1402 may include a unique parent code 1404 that can be used to associate every one of the products 1406 with the seller that receives the package 1402. This may eliminate scanning every product at shipment. In one embodiment, the unique parent code may include an RFID tag that is scanned at shipment. In one embodiment, the products 1406 may be samples that are packaged together but are assigned to a seller using a single unique parent code 1404.

In the QR code embodiment, a seller may have a sheet of QR codes that he/she can apply to products. Alternatively, the product label may be printed with the QR code and upon shipping (when the seller to receive the product becomes known), the unique identifier is associated that seller. In other embodiments, when the consumer activates the QR code, the consumer may receive additional product information (instructions, advertisements, upsetting, multimedia, etc.). When the QR code is printed, it may already encode the unique identifier, however, that unique identifier is not associated with a seller until the product is ready to be transferred/shipped to the seller.

In addition to providing a connection between customers and a seller, the unique identifier may allow for additional tracking and monitoring of products. For example, back stock that has not been sold may be easier to track. The percentage of products that a seller uses for themselves versus sells can also be tracked. Product flow and timing of the flow can be analyzed based on the tracking.

Fraud protection can be improved by comparing the country code (from the unique identifier) with a country in which the product was scanned (from the mobile device geo location). If the countries do not match, there may be a gray market goods problem that can be investigated. Further, when the unique identifier includes enough characters, it becomes more difficult to counterfeit.

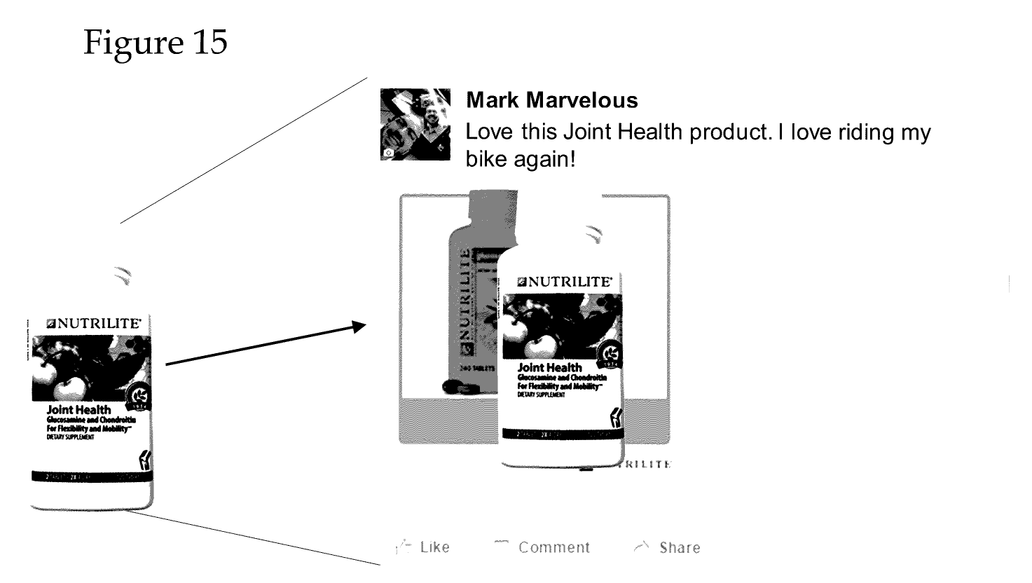

Referring back to FIG. 9, the user is provided with multiple options after scanning a QR code on a product. When a user clicks on Share 908, the user can share information about the product. Options for sharing may include email, text messaging, instant messaging, or social media (e.g. FACEBOOK, TWITTER, etc.). FIG. 15 illustrates one example for sharing product information. FIG. 15 illustrates that a user scans a vitamin QR code and then selects Share 908, which automatically provides a link or opens a social media page (e.g. opens the page on a browser or connects with an app for the social media provider). The user can then add a comment and post the information about the product on the social media page. In one embodiment, the sharing option may link to an internal MLM site (i.e. an Amway webpage). The sharing feature that posts to social media can also have current photo content provided by the MLM organization that aligns with current campaign look and/or messaging.

In another embodiment, the link may be to a seller's specific pages. In other words, the seller may have their own website for selling products, so a user clicking the QR code and wishing to share may be sent to a web page of the seller's site for generating a posting for the user's social media page. In that way, the seller can receive credit for any sales that are related to the social media posting. When a seller (i.e. ABO or IBO) rather than a user wishes to share product information from clicking on a product QR code, the sharing may be specific to the seller's downline. Any future sales from the sharing post may be easily credited back to the seller because the social media link or display may include the unique ID which identifies the seller.

The system and process described above may be encoded in a signal bearing medium, a computer readable medium such as a memory, programmed within a device such as one or more integrated circuits, one or more processors or processed by a controller or a computer. That data may be analyzed in a computer system and used to generate a spectrum. If the methods are performed by software, the software may reside in a memory resident to or interfaced to a storage device, synchronizer, a communication interface, or non-volatile or volatile memory in communication with a transmitter. A circuit or electronic device designed to send data to another location. The memory may include an ordered listing of executable instructions for implementing logical functions. A logical function or any system element described may be implemented through optic circuitry, digital circuitry, through source code, through analog circuitry, through an analog source such as an analog electrical, audio, or video signal or a combination. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine readable medium,” “propagated-signal” medium, and/or “signal-bearing medium” may comprise any device that includes stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM”, a Read-Only Memory “ROM”, an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description. While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for order processing comprising:
tagging products with individual unique identifiers;
providing a mechanism for reordering one of the products which communicates the unique identifier for the one of the products;
identifying the seller associated with the unique identifier; and
assigning credit for the reordering of the one of the products.

2. The method of claim 1 wherein the credit comprises points within a multi-level marketing organization.

3. The method of claim 2 wherein the points equate to money paid based on sales.

4. The method of claim 1 wherein the mechanism comprises a QR code and the tagging comprises labeling each of the products with a unique QR code.

5. The method of claim 4 further comprising:
recording, before shipment to the seller, the association of the unique identifier with the seller.

6. The method of claim 4 further comprising:
receiving, from a mobile device scanning the QR code, the unique identifier for a reordering of the product.

7. The method of claim 1 wherein the mechanism comprises an RFID code and the tagging comprises adding a unique RFID code to each of the products.

8. The method of claim 1 further comprising:
providing a relational database storing each of the unique identifiers and an identification of each seller which receives each product associated with one of the unique identifiers.

9. The method of claim 8 wherein the relational database includes a country code associated with each of the products to prevent fraud by determining whether sales of the product occur in a correct country.

10. A method for product ordering comprising:
receiving an order request for a product from a mobile device;
receiving a unique identifier with the order request, wherein the unique identifier is transmitted upon scanning of a code on the product, wherein each product includes a unique identifier;
identifying a seller associated with the received unique identifier by checking a database that associates unique identifiers of products sold with sellers of those products; and
assigning credit to the identified seller for the order request.

11. The method of claim 10 wherein the code comprises a QR code that is scanned by the mobile device.

12. The method of claim 10 wherein the order request comprises a reordering of a product sold by a seller to a user of the mobile device.

13. A system for product tracking comprising:
a database for associating a unique identifier with each product;
a tracker, coupled with the database, that receives an order request from user device that includes one of the unique identifiers, the tracker comprising:
a tagger that tags a product with a unique identifier;
an associator that associates the unique identifier with a seller who receives the product, wherein the association is stored in the database;
an order processor that receives an order request and the unique identifier; and
a creditor for assigning credit to the seller for the order.

14. The system of claim 13 wherein the order request comprises a reordering of another one of the product.

15. The system of claim 13 wherein the assigning credit is part of a multilevel marketing organization.

16. The system of claim 13 wherein the database associates unique identifiers with individual products and a seller who receives that particular product.

17. The system of claim 16 wherein the database stores a country code to identify a country for each of the products to prevent fraud.

18. The system of claim 13 wherein the tagger adds a QR code to the product, wherein the QR code encodes the unique identifier.

19. The system of claim 18 wherein user device comprises a mobile device with a QR code scanner.

20. The system of claim 19 wherein the order request is generated when the scanner scans the QR code.
